(19) United States
(12) Patent Application Publication
(10) Pub. No.: US 2002/0080421 A1
(43) Pub. Date: Jun. 27, 2002

(54) Dual direction driving apparatus and method for driving optical scanning module of image scanning device

(76) Inventor: Chui-Kuei Chiu, Hsinchu Hsian (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/745,872

(22) Filed: Dec. 26, 2000

(51) Int. Cl. H04N 1/04; H04N 1/46

(52) U.S. Cl. 358/474; 358/505

(57) ABSTRACT

A dual direction driving apparatus and method for driving an optical scanning module of an image scanning device are provided. The driving apparatus includes a first driving mechanism installed in the scanner and a second driving mechanism installed in the optical scanning module. The first driving mechanism and the second driving mechanism are simultaneously driven in order to drive the optical scanning module to move along a driving direction for performing image scanning on a document to be scanned. The second driving mechanism drives the optical scanning module to move in either the same or opposite direction with respect to the driving direction of the first driving mechanism for responding to different scanning resolution requirements of scanning operations.

### BACKGROUND OF THE INVENTION

1. Field of the Invention

The present invention relates to a driving technique of an image scanning device, and more especially to a dual direction driving apparatus and method for driving an optical scanning module of the image scanning device.

2. Description of the Prior Art

Conventional flat-bed image scanning devices have been widely used to scan/read image of documents, configured as shown in FIGS. 1 and 2. The conventional scanner comprises a scanner frame 11, a light transmittable document positioning plate 12 for positioning the document to be scanned, an optical scanning module 13, and a pair of guiding rails 14a, 14b. Also referring to FIG. 3, the optical scanning module 13 comprises an image sensing element 14 such as a charge coupling device (CCD) or a contact image scanning (CIS), a focus lens 15, a light source 16, and a plurality of light reflection mirrors 171, 172, 173, and 174.

The optical scanning module 13 is driven by a conventional driving mechanism comprising such as a motor 18 and a transmission rope 19, and moved along the guiding rails 14a, 14b for scanning the original document 2 positioned on the document positioning plate 12. In the conventional mechanism designing, the optical scanning module 13 is driven by a single driving module for movement. For example, one end of the optical scanning module 13 is fixed on the transmission rope 19 by a fixing component 131. Therefore, the optical scanning module 13 may be moved along the guiding rails 14a, 14b when the transmission rope 19 is driven by the motor 18.

It is known that the scanning resolution of the scanner is determined by the moved distance per unit time of the optical scanning module. When a high scanning resolution is required, the optical scanning module has to be moved for a relatively short distance per unit time, i.e., the moving speed is relatively low. On the contrary, when a low scanning resolution is required, the optical scanning module has to be moved for a relatively long distance per unit time, i.e., the moving speed is relatively high. In the conventional technique, the scanner can not provide both high and low resolution scanning functions because it utilizes a single driving mechanism for moving the optical scanning module.

For example, if a same driving mechanism is used for resulted in two scanning resolutions 50 dpi and 2400 dpi, the ratio between the corresponding moving speeds of the optical scanning module for the two resolutions is 48. It will be very difficult if a single driving mechanism is used for achieving the two different scanning resolutions with such a wide range. In case that a single driving mechanism for the optical scanning module is desired to meet the requirements of both high and low scanning resolutions, the component cost of the driving motor will be increased, the torque of the motor will be decreased, and the designing difficulty will be increased.

Thus, it is desirable to provide a new driving mechanism for the optical scanning module of the image scanning device to overcome the problems described above and facilitate scanning operation.

### SUMMARY OF THE INVENTION

Consequently, a primary purpose of the present invention is to provide a driving apparatus for an optical scanning module of a scanner. The driving apparatus comprises a first driving mechanism installed in the scanner, a second driving mechanism installed in the optical scanning module and engaged with the first driving mechanism. The optical scanning module may move on the first driving mechanism when driven by the second driving mechanism for scanning an original document positioned in the scanner.

Another purpose of the present invention is to provide a dual direction driving apparatus for an optical scanning module of a scanner. The optical scanning module may be moved by cooperation of a first driving mechanism and a second driving mechanism of the driving apparatus. The first driving mechanism and the second driving mechanism may provide the same or the opposite driving directions so that the optical scanning module can scan a document to be scanned with different speeds for meeting the different resolution requirements.

Further another purpose of the present invention is to provide a dual direction driving method for an optical scanning module of a scanner. A first driving mechanism is firstly driven to move in a first transmission direction. Simultaneously, a second driving mechanism is driven to move in a second transmission direction. The optical scanning module is driven by cooperation of the first driving mechanism and the second driving mechanism and moved along the first transmission direction for scanning a document positioned in the scanner.

Accordingly, one aspect of the present invention is to provide a dual direction driving apparatus for driving an optical scanning module of a scanner to move with respect to an original document to be scanned. The driving apparatus comprises a first driving mechanism installed in the scanner, and a second driving mechanism installed in the optical scanning module and movably engaging with the first driving mechanism. The optical scanning module is driven by the second driving mechanism to engageably move with respect to the first driving mechanism for scanning the original document to be scanned.

Another aspect of the present invention is to provide a dual direction driving method for driving an optical scanning module of a scanner. The method comprises steps of providing a first driving mechanism installed in the scanner and driving the optical scanning module in a first direction, providing a second driving mechanism which is installed in the optical scanning module and driving the optical scanning module to move in a second direction parallel to the first direction, and scanning an original document to be scanned by movement of the optical scanning module.

### BRIEF DESCRIPTION OF THE DRAWINGS

FIG. 1 is a perspective view of a conventional flat-bed image scanning device;

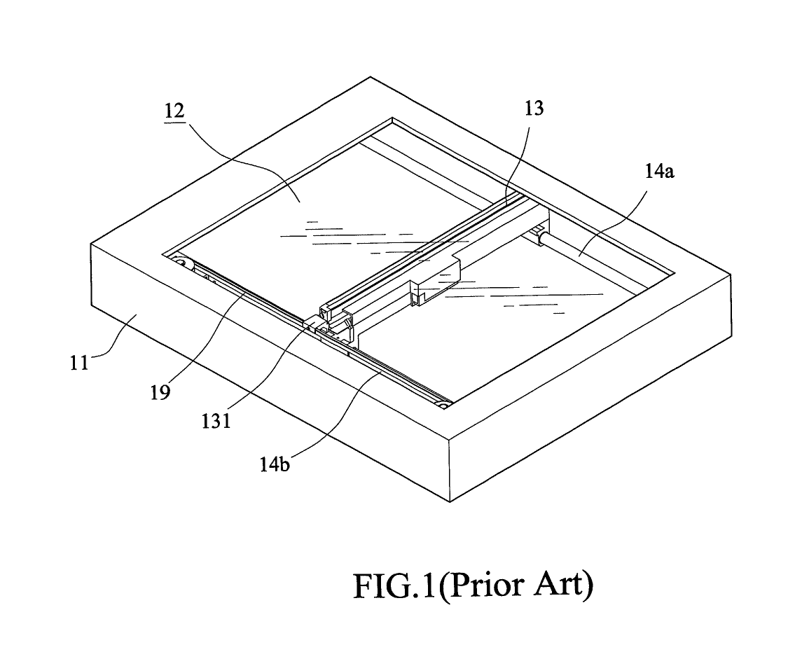

FIG. 2 is a partially exploded perspective view illustrating a driving mechanism is arranged in the conventional image scanning device of FIG. 1;

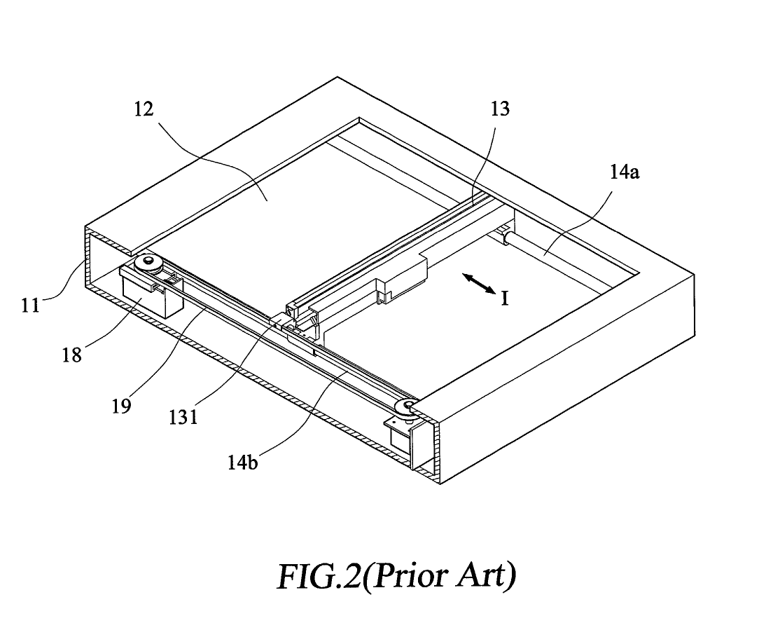

FIG. 3 is a schematic view showing an optical path of the conventional scanner of FIG. 1;

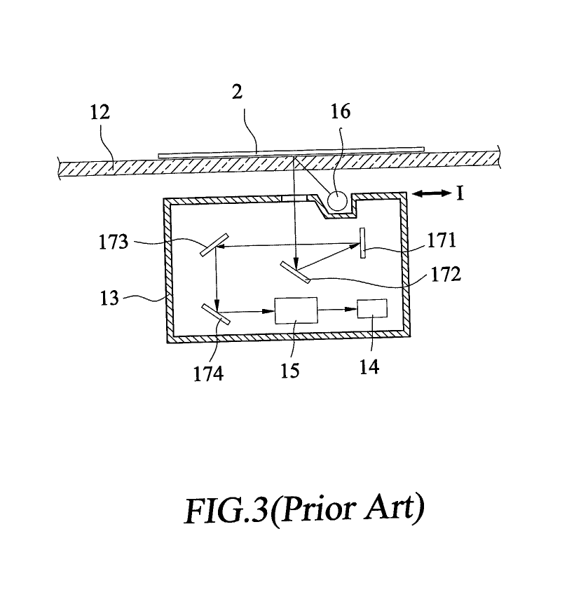

FIG. 4 is a perspective view of a first embodiment of the present invention;

FIG. 5 is a partially exploded perspective view showing a driving mechanism of the present invention is arranged in the image scanning device of FIG. 4;

FIG. 6 is a schematic view showing an optical path of the scanner of FIG. 5;

FIG. 7 is a perspective view of a second embodiment of the present invention; and

FIG. 8 is a perspective view of a third embodiment of the present invention.

### DETAILED DESCRIPTION OF THE PREFERRED EMBODIMENTS

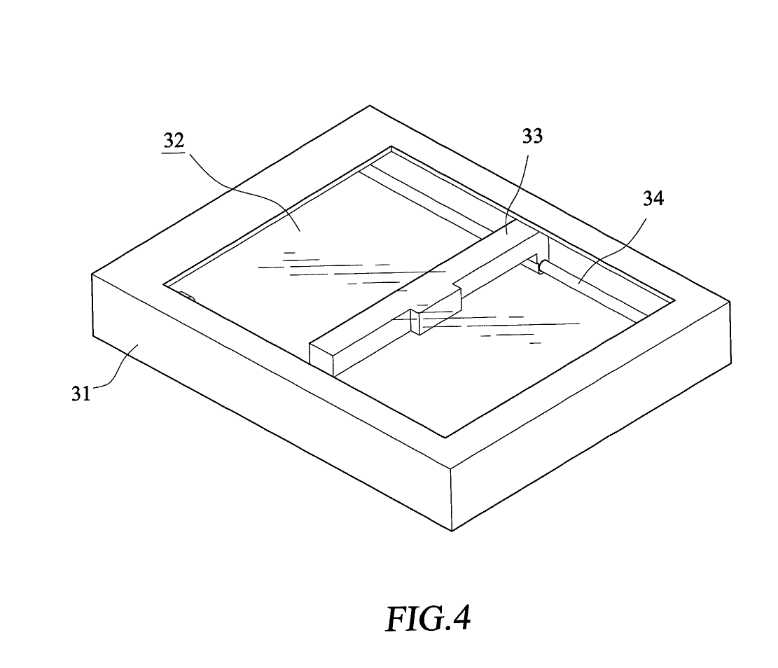

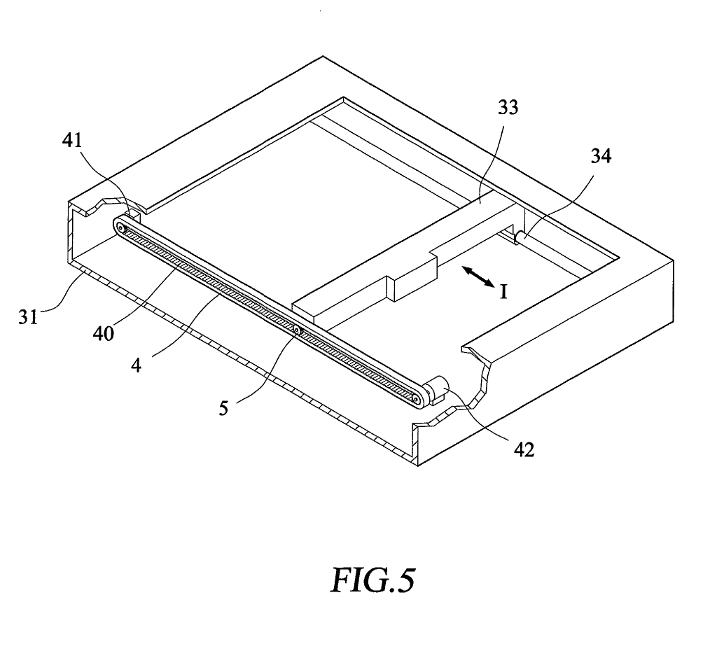

Referring to FIGS. 4 and 5, a first embodiment of a dual direction driving apparatus for an optical scanning module of a scanner is shown. The driving apparatus comprises a scanner frame 31, a document positioning plate 32 for position of a document to be scanned, an optical scanning module 33, and a guiding rail 34.

A transmission belt 4 is arranged in the scanner frame 31. The transmission belt 4 extends along the moving direction of the optical scanning module 33 and it is fixed at one end thereof by a fixing component 41 while driven by a driving motor 42 at the other end. The transmission belt 4 and the driving motor 42 together constitute a first driving mechanism for moving the optical scanning module 33 with respect to the document positioning plate 32 mounted on the scanner frame 31, where an original document to be scanned is located.

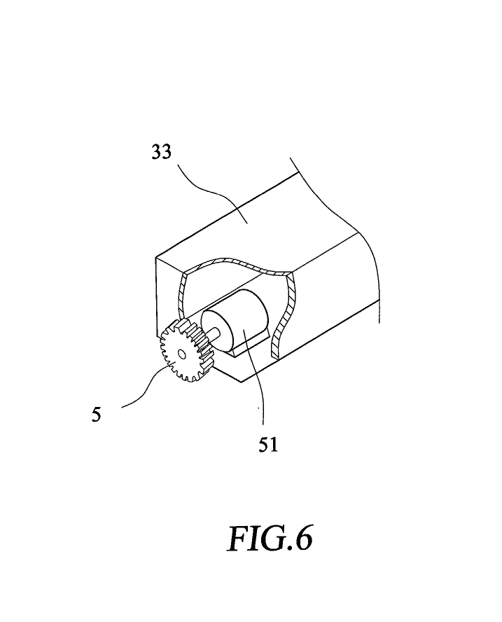

Also referring to FIG. 6, a gear 5 extends from one end of the optical scanning module 33 and it can be driven by a driving motor 51 arranged in the optical scanning module 33. The gear 5 together with the driving motor 51 constitute a second driving mechanism of the present invention for moving the optical scanning module 33 with respect to the transmission belt 4.

When the gear 5 and the driving motor 51 operate, the optical scanning module 33 may be driven to move along the guiding rail 34 and the transmission belt 4 because the gear 5 engages with an inner tooth portion 40 formed in an inner periphery of the transmission belt 4. Therefore, the moving speed of the optical scanning module 33 with respective to the document to be scanned may be calculated from two components, one driven by the first driving mechanism and the other driven by the second driving mechanism.

Suppose the moving speed of the optical scanning module 33 due to the gear 5 and the driving motor 51 is V1 and suppose the moving speed of the optical scanning module 33 due to the transmission belt 4 and the driving motor 42 is V2. If V1 and V2 are in the same direction, the finalized moving speed V of the optical scanning module 33 with respect to the document to be scanned will be V1 plus V2 (i.e., V=V1+V2). This speed is relatively high suitable for low resolution scanning.

If V1 and V2 are in the opposite direction, the finalized moving speed V of the optical scanning module 33 with respect to the document to be scanned will be V1 minus V2 (i.e., V=V1−V2). This speed is relatively low suitable for high resolution scanning.

The driving motors 42, 51 may be well known stepping motors or DC motors. If the driving motors 42, 51 are stepping motors, the stepping modes thereof may be full step, half step, quarter step, or one eighth step. Therefore, the speed modes of the optical scanning module 33 may be varied according to the different rotation directions and stepping modes of the stepping motors 42, 51.

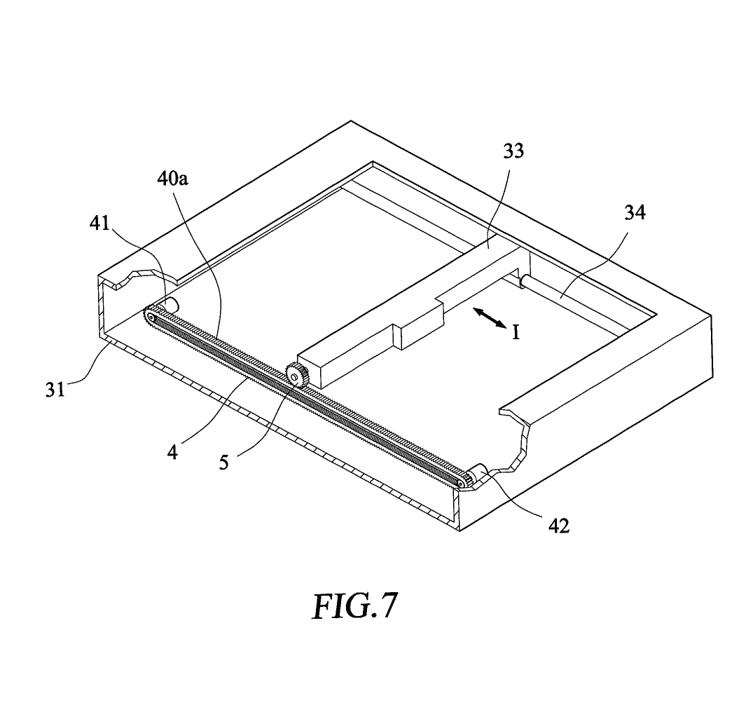

Referring to FIG. 7, a second embodiment of the driving apparatus is shown. The second embodiment is similar to the first embodiment except that the transmission belt 4 of the first driving mechanism has an outer tooth portion 43 formed on the outer periphery thereof and capable of engaging with the gear 5 of the second driving mechanism of the scanner.

The transmission theory of the second embodiment is similar to that of the first embodiment. Suppose the moving speed of the optical scanning module 33 due to the gear 5 and the driving motor 51 is V1 and suppose the moving speed of the optical scanning module 33 due to the transmission belt 4 and the driving motor 42 is V2. If V1 and V2 are in the same direction, the finalized moving speed V of the optical scanning module 33 with respect to the document to be scanned will be V1 plus V2 (i.e., V=V1+V2). If V1 and V2 are in the opposite direction, the finalized moving speed V of the optical scanning module 33 with respect to the document to be scanned will be V1 minus V2 (i.e., V=V1−V2).

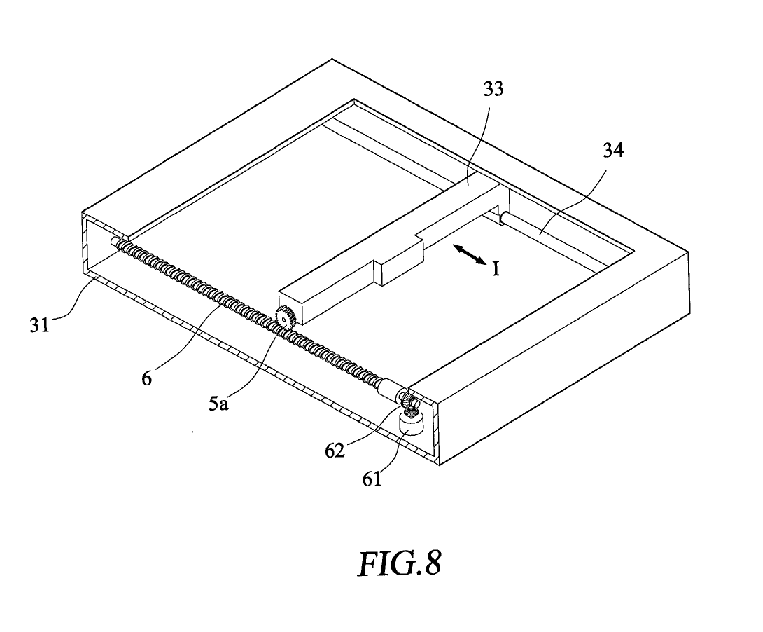

Referring to FIG. 8, a third embodiment of the driving apparatus is shown. Similar to the previous two embodiments described above, the third embodiment comprises a first driving mechanism for carrying the optical scanning module 33 to move with respect to the document to be scanned and a second driving mechanism installed associated with the optical scanning module 33 for directly driving the optical scanning module 33 to move with respect to the first driving mechanism.

In the third embodiment, the first driving mechanism comprises a threaded guiding rod 6, a driving motor 61, and a slant gear assembly 62 driven by the driving motor 61 and engaged with the threaded guiding rod 6. The second driving mechanism is similar to that of the first embodiment except that the gear 5 of FIG. 6 is replaced by a slant gear 5a. The slant gear 5a is used to engage with the threaded guiding rod 6. The threaded guiding rod 6 is driven to rotate by the driving motor 61 and the slant gear assembly 62. The optical scanning module 33 will be moved along the guiding rail 34 and the threaded guiding rod 6 when the threaded guiding rod 6 is driven to rotate. The optical scanning module 33 may also move with respect to the document to be scanned when it is driven by the second driving mechanism which comprises the slant gear 5a and the driving motor 51 (see FIG. 6).

Similar to the previous two embodiments, there are two moving speeds for the optical scanning module 33, one from the first driving mechanism and the other from the second driving mechanism. Suppose the moving speed of the optical scanning module 33 due to the slant gear 5a and the driving motor 51 is V1 and suppose the moving speed of the optical scanning module 33 due to the threaded guiding rod 6, the driving motor 61, and the slant gear assembly 62 is V2. If V1 and V2 are in the same direction, the finalized moving speed V of the optical scanning module 33 with respect to the document to be scanned will be V1 plus V2 (V=V1+V2). If V1 and V2 are in the opposite direction, the finalized moving speed V of the optical scanning module 33 with respect to the document to be scanned will be V1 minus V2 (V=V1−V2).

From the above embodiments, it can be appreciated that the scanning speed may be increased or decreased via cooperation of the first driving mechanism and the second driving mechanism for meeting different resolution requirements of the scanner. The moving speed of the optical scanning module may be determined by the relative movement between the first driving mechanism and the second driving mechanism, which in turn determines the scanning resolution of the scanner. If the moving speeds caused by the two driving mechanism are in the same direction, the finalized moving speed will be a plus result of both speed components, otherwise the finalized moving speed will be a minus result of the two speed components. Accordingly, the scanning speed and the scanning resolution can be well controlled by the cooperation of the two driving mechanisms.

While the present invention has been described with reference to the specific embodiments, the description is illustrative of the invention and is not to be construed as limiting the invention. Therefore, various modifications to the present invention can be made to the preferred embodiments by those skilled in the art without departing from the true spirit and scope of the invention as defined by the appended claims.

What is claimed is:

1. A dual direction driving apparatus for driving an optical scanning module of an image scanning device to move with respect to a document placed on a document positioning plate of the image scanning device, the driving apparatus comprising:
a first driving mechanism installed in the scanner; and
a second driving mechanism installed in the optical scanning module and movably engaging with the first driving mechanism;
wherein the optical scanning module is driven by the second driving mechanism to engageably move with respect to the first driving mechanism for scanning the document to be scanned.

2. The driving apparatus as claimed in claim 1, wherein the first driving mechanism comprises a transmission belt extending along a moving direction of the optical scanning module and a first driving motor for driving the transmission belt to move, and the second mechanism comprises a gear extending from one end of the optical scanning module and engaging with the transmission belt of the first driving mechanism and a second driving motor for driving the gear to rotate.

3. The dual direction driving apparatus as claimed in claim 2, wherein the transmission belt of the first driving mechanism comprises an inner tooth portion formed in an inner periphery thereof for engaging with the gear of the second driving mechanism.

4. The dual direction driving apparatus as claimed in claim 2, wherein the transmission belt of the first driving mechanism comprises an outer tooth portion formed in an outer periphery thereof for engaging with the gear of the second driving mechanism.

5. The dual direction driving apparatus as claimed in claim 2, wherein the first driving motor and the second driving motor are stepping motors.

6. The dual direction driving apparatus as claimed in claim 1, wherein the first driving mechanism comprises a threaded guiding rod, a first driving motor, and a slant gear assembly, the threaded guiding rod being driven by the first driving motor via the slant gear assembly, and wherein the second mechanism comprises a slant gear extending from one end of the optical scanning module and engaging with the threaded guiding rod of the first driving mechanism and a second driving motor for driving the slant gear to rotate.

7. The dual direction driving apparatus as claimed in claim 6, wherein the first driving motor and the second driving motor are stepping motors.

8. The dual direction driving apparatus as claimed in claim 1, wherein the second driving mechanism and the first driving mechanism move the optical scanning module in a same direction.

9. The dual direction driving apparatus as claimed in claim 1, wherein the second driving mechanism and the first driving mechanism move the optical scanning module in opposite directions.

10. A dual direction driving method for driving an optical scanning module of a scanner to move with respect to a document placed on a document positioning plate of the image scanning device, comprising steps of:
(a) providing a first driving mechanism installed in the scanner;
(b) providing a second driving mechanism which is installed in the optical scanning module; and
(c) transmitting the optical scanning module in a first direction and simultaneously drives the optical scanning module to move in a second direction with respect to the first direction to scan the document.

11. The dual direction driving method as claimed in claim 10, wherein the first direction and the second direction are same direction.

12. The dual direction driving method as claimed in claim 10, wherein the first direction and the second direction are opposite directions.
